(19) United States
(12) Patent Application Publication
(10) Pub. No.: US 2016/0182853 A1
(43) Pub. Date: Jun. 23, 2016

(54) Dynamic Content Adaptive Frame Rate Conversion

(71) Applicant: MediaTek Inc., Hsinchu (TW)

(72) Inventors: Chin-Chuan Liang, Hsinchu (TW); Shang-Hsiu Wu, Hsinchu County (TW); Ying-Jui Chen, Hsinchu County (TW); Te-Hao Chang, Taipei (TW)

(21) Appl. No.: 15/058,120

(22) Filed: Mar. 1, 2016

Related U.S. Application Data
(60) Provisional application No. 62/135,940, filed on Mar. 20, 2015.

(51) Int. Cl. H04N 7/01; H04N 19/44; G06T 7/40; G06K 9/00; G06T 7/20

(52) U.S. Cl. CPC H04N 7/0127; G06K 9/00711; G06T 7/2006; G06T 7/40; H04N 19/44; G06T 2207/10016

(57) ABSTRACT

A technique, as well as select implementations thereof, pertaining to dynamic content adaptive frame rate conversion is described. The technique may involve analyzing information associated with two or more video frames of a stream of video frames. The technique may also involve dynamically adjusting a frame rate of the two or more video frames of the stream of video frames based on a result of the analyzing.

### CROSS REFERENCE TO RELATED PATENT APPLICATIONS

The present disclosure claims the priority benefit of U.S. Provisional Patent Application No. 62/135,940, filed on 30 Mar. 2015, which is incorporated by reference in their entirety.

### TECHNICAL FIELD

The present disclosure is generally related to frame rate conversion and, more particularly, to methods, devices and apparatuses of dynamic content adaptive frame rate conversion.

### BACKGROUND

Unless otherwise indicated herein, approaches described in this section are not prior art to the claims listed below and are not admitted to be prior art by inclusion in this section.

Frame rate, also known as frame frequency, is the rate/frequency at which an imaging device displays consecutive images (e.g., video frames). Frame rate conversion (FRC) refers to the conversion of frame rate of a stream of video frames from a source frame rate to a display frame rate which is typically greater than the source frame rate. There are generally two approaches to FRC as shown in example 600 of FIG. 6. A first approach, referred to as normal FRC herein and shown in part (A) of FIG. 6, involves frame repetition and a second approach, referred to as motion-compensated (MC) FRC herein and shown in part (B) of FIG. 6, involves interpolation of motion-compensated frames. In mobile applications such as smartphones, tablet computers and wearable devices, however, given the limited resources (e.g., memory and battery power) there is a need to conserve memory bandwidth and power consumption used for FRC.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve analyzing information associated with two or more video frames of a stream of video frames. The method may also involve dynamically adjusting a frame rate of at least the two or more video frames of the stream of video frames based on a result of the analyzing.

In another example implementation, a device may include a FRC module configured to perform a number of operations. The FRC module may analyze information associated with two or more video frames of a stream of video frames. The FRC module may also dynamically adjust a frame rate of at least the two or more video frames of the stream of video frames based on a result of the analyzing.

In yet another example implementation, an apparatus may include a FRC module and a display processing module. The FRC module may be configured to perform a number of operations. The FRC module may analyze information associated with two or more video frames of a stream of video frames. The FRC module may also dynamically adjust a frame rate of at least the two or more video frames of the stream of video frames based on a result of the analyzing. The display processing module may be configured to process the stream of video frames.

Thus, implementations in accordance with the present disclosure analyze the content of source video frames and dynamically adjust an output frame rate of FRC. Advantageously, both memory bandwidth and power consumption may be reduced as a result of utilizing the dynamic content adaptive FRC in accordance with the present disclosure. Accordingly, applications where resources such as memory and power are limited, such as mobile applications, can significantly benefit from techniques, methods, devices and apparatuses in accordance with the present disclosure.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of various example architectures in accordance with an implementation of the present disclosure.

FIG. 2A is a block diagram of an example device for FRC in accordance with an implementation of the present disclosure.

FIG. 2B is a block diagram of an example device for FRC in accordance with another implementation of the present disclosure.

FIG. 3 is a block diagram of an example device for FRC in accordance with a further implementation of the present disclosure.

FIG. 4 is a block diagram of example apparatuses in accordance with an implementation of the present disclosure.

FIG. 5 is a flowchart of an example process in accordance with an implementation of the present disclosure.

FIG. 6 is a diagram of normal FRC and motion-compensated FRC.

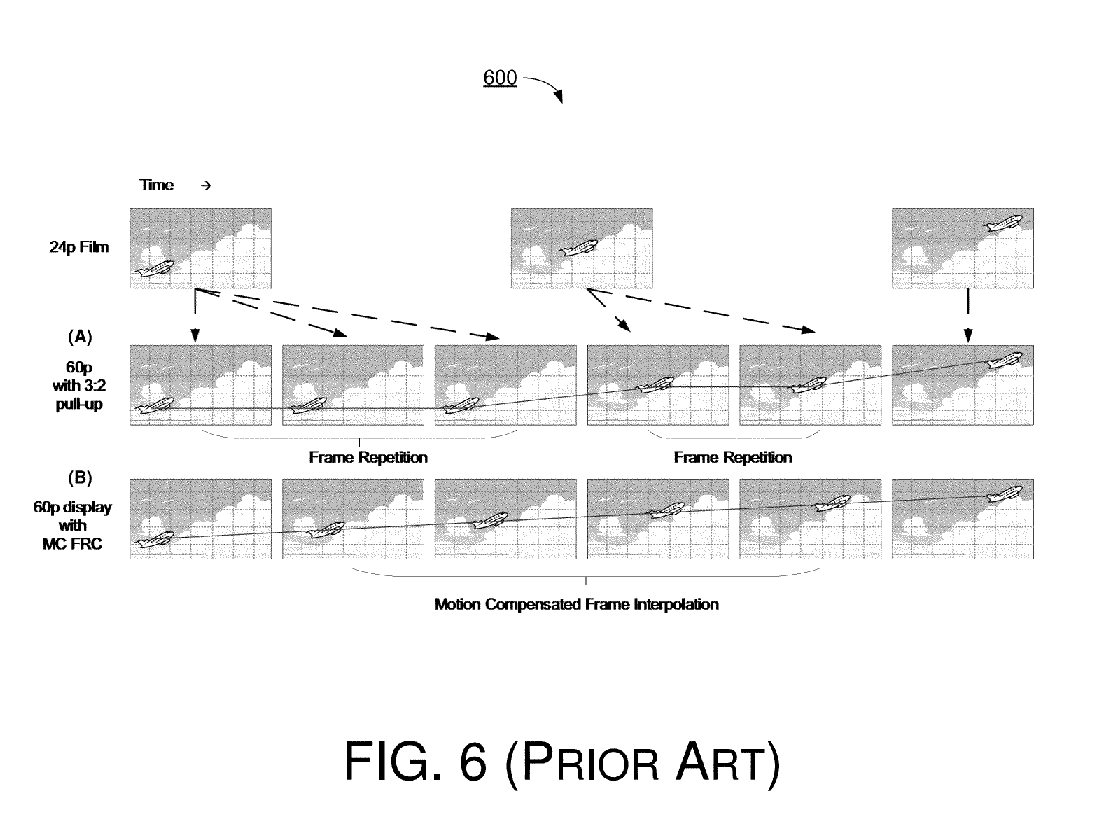

### DETAILED DESCRIPTION OF PREFERRED EMBODIMENTS

### Overview

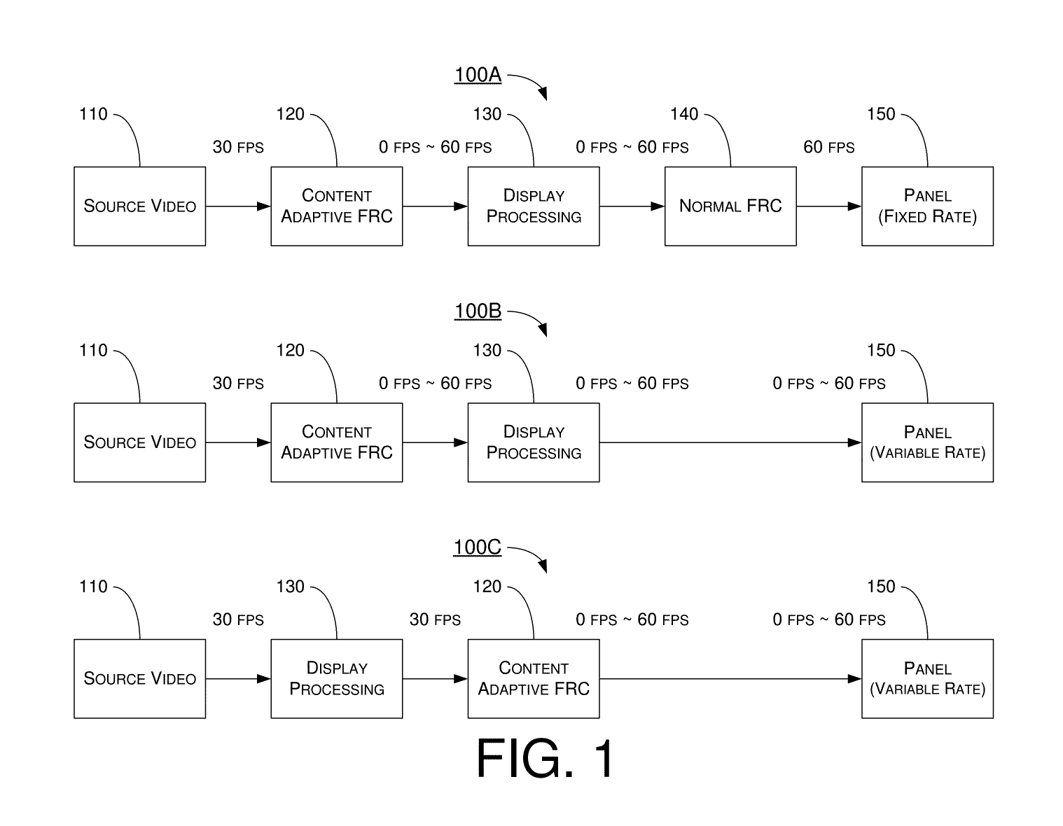

FIG. 1 illustrates example architecture 100A, example architecture 100B and example architecture 100C in accordance with an implementation of the present disclosure. In each of architecture 100A, architecture 100B and architecture 100C, content adaptive FRC is performed to dynamically adjust an output frame rate of the FRC as a result of analysis of the content of source video frames. Advantageously, this may result in reduced memory bandwidth requirement as well as reduced power consumption.

Referring to FIG. 1, architecture 100A may include a source video module 110, a content adaptive FRC module 120, a display processing module 130, a normal FRC (or motion-compensated FRC) module 140 and a panel 150. In the example shown in FIG. 1, source video module 110 may provide a stream of source video frames at a source frame rate of 30 frames per second (fps). Content adaptive FRC module 120 may receive the stream of source video frames at 30 fps from source video module 110 to output a stream of output video frames at an output frame rate which is dynamically adjusted as a result of analysis of the content of at least some of the video frames of the stream of source video frames. The output frame rate may be, for example and not limited thereto, somewhere between 0 fps and 60 fps. Display processing module 130 may process the stream of output video frames without changing the frame rate thereof. Normal FRC module 140 may perform normal FRC (e.g., frame repetition) to result in a frame rate of 60 fps, for example, at the output thereof. Panel 150 may be configured to receive video frames at a fixed frame rate, and may receive the stream of video frames from normal FRC module 140 to display the video frames.

Referring to FIG. 1, architecture 1008 may include source video module 110, content adaptive FRC module 120, display processing module 130 and a panel 150. In the example shown in FIG. 1, source video module 110 may provide a stream of source video frames at a source frame rate of 30 fps. Content adaptive FRC module 120 may receive the stream of source video frames at 30 fps from source video module 110 to output a stream of output video frames at an output frame rate which is dynamically adjusted as a result of analysis of the content of at least some of the video frames of the stream of source video frames. The output frame rate may be, for example and not limited thereto, somewhere between 0 fps and 60 fps. Display processing module 130 may process the stream of output video frames without changing the frame rate thereof. Panel 150 may be configured to receive video frames at a variable frame rate, and may receive the stream of video frames from normal FRC module 140 to display the video frames.

Referring to FIG. 1, architecture 100C may include source video module 110, display processing module 130, content adaptive FRC module 120 and a panel 150. In the example shown in FIG. 1, source video module 110 may provide a stream of source video frames at a source frame rate of 30 fps. Display processing module 130 may process the stream of source video frames without changing the frame rate thereof. Content adaptive FRC module 120 may receive the stream of source video frames at 30 fps from display processing module 130 to output a stream of output video frames at an output frame rate which is dynamically adjusted as a result of analysis of the content of at least some of the video frames of the stream of source video frames. The output frame rate may be, for example and not limited thereto, somewhere between 0 fps and 60 fps. Panel 150 may be configured to receive video frames at a variable frame rate, and may receive the stream of video frames from normal FRC module 140 to display the video frames.

In some cases, each of architecture 100A, architecture 1008 and architecture 100C may be modified in that functionalities of content adaptive FRC module 120 may be implemented in the midst of display processing. That is, content adaptive FRC may be performed as part of display processing by display processing module 130 modified accordingly. For instance, a modified display processing module 130 may perform some display processing, followed by content adaptive FRC which is then followed by some further display processing.

Moreover, in architecture 100C, there may be a post-processing module (not shown) between content adaptive FRC module 120 and panel 150. The post-processing module may perform color processing and/or provide one or more user interface (UI) functionalities.

### Example Implementations

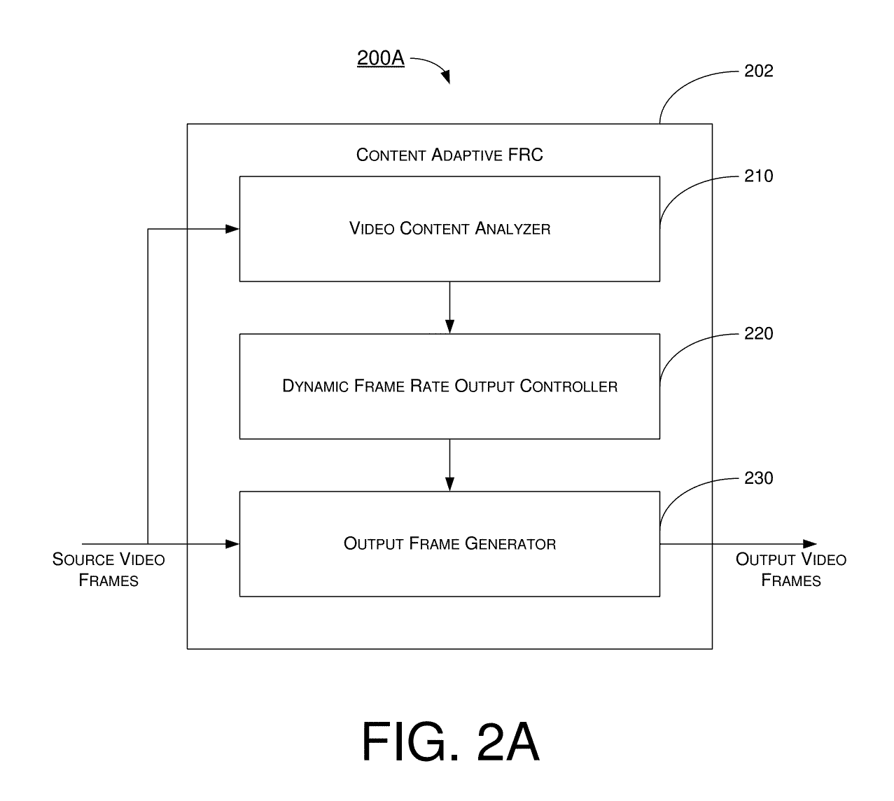

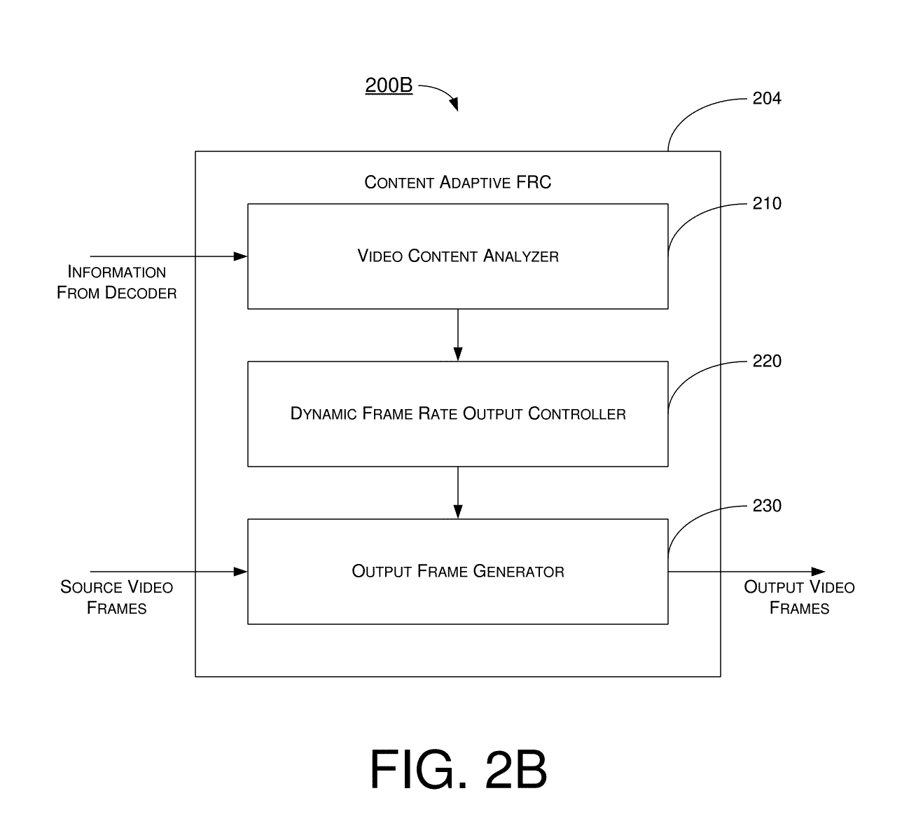

FIG. 2A illustrates an example device 200A for FRC in accordance with an implementation of the present disclosure. Device 200A may perform various functions to implement techniques, processes and methods described herein, including at least a portion of architecture 100A, architecture 1008, architecture 100C described above as well as process 500 described below. Device 200A may be implemented in the form of a single integrated-circuit (IC) chip or a chipset of multiple IC chips. For instance, device 200A may be a processor such as a central processing unit (CPU), a graphics processing unit (GPU) or an applications-specific IC (ASIC). Device 200A may include a content adaptive FRC module 202.

Content adaptive FRC module 202 may be configured to receive a stream of video frames, analyze information associated with two or more video frames of the stream of video frames, and dynamically adjust a frame rate of at least the two or more video frames of the stream of video frames based on a result of the analyzing. In some implementations, as shown in FIG. 2A, content adaptive FRC module 202 may include at least those components shown in FIG. 2A, such as a video content analyzer 210, a dynamic frame rate output controller 220 and an output frame generator 230.

Content adaptive FRC module 202 may be in the form of hardware, software, middleware, firmware or any combination thereof. For example, content adaptive FRC module 202 may be implemented in a hardware form of a circuit or IC chip. As another example, content adaptive FRC module 202 may be implemented in a software form such as one or more sets of instructions executable by a CPU, a GPU or an ASIC.

In some implementations, video content analyzer 210 may be configured to analyze a content of every two or more consecutive video frames of the stream of source video frames. Dynamic frame rate output controller 220 may be configured to dynamically adjust the frame rate of at least the two or more video frames of the stream of source video frames based on a result of analyzing by the video content analyzer 210. Output frame generator 230 may be configured to receive the stream of source video frames (e.g., from source video module 110 as in architecture 100A and architecture 1008, or from display processing module 130 as in architecture 100C) at a source frame rate and output a stream of output video frames at an output frame rate.

In some implementations, video content analyzer 210 may be configured to obtain information on the content of every two or more consecutive video frames from the stream of source video frames. In some implementations, in analyzing the content of every two or more consecutive video frames of the stream of source video frames, video content analyzer 210 may be configured to analyze a texture, a motion speed, a motion complexity, or a combination thereof regarding the content of every two or more consecutive video frames of the stream of source video frames.

In some implementations, in dynamically adjusting the frame rate of at least the two or more video frames, dynamic frame rate output controller 220 may be configured to maintain the frame rate of at least the two or more video frames at the source frame rate based on the result of the analyzing. For instance, for a still scene (e.g., no motion), dynamic frame rate output controller 220 may maintain the source frame rate without making adjustment. As another example, for a still scene (e.g., no motion), dynamic frame rate output controller 220 may decrease the frame rate by skipping one or more similar video frames from the stream of source video frames in providing a stream of output video frames. As a further example, for a complicated scene (e.g., multiple motions such as a fighting scene or sports scene), dynamic frame rate output controller 220 may maintain the source frame rate without making adjustment, since the effect of up-conversion may be limited.

Alternatively or additionally, in dynamically adjusting the frame rate of at least the two or more video frames, dynamic frame rate output controller 220 may be configured to adjust the frame rate of at least the two or more video frames to be between the source frame rate and a display frame rate based on the result of the analyzing, where the display frame rate is different from (e.g., greater than or less than) the source frame rate. For instance, for a near-still or slow-speed scene, dynamic frame rate output controller 220 may adjust the output frame rate to be between the source frame rate and the display frame rate.

Alternatively or additionally, in dynamically adjusting the frame rate of at least the two or more video frames, dynamic frame rate output controller 220 may be configured to increase the frame rate of at least the two or more video frames to a display frame rate greater than the source frame rate based on the result of the analyzing. For instance, for a normal motion scene, dynamic frame rate output controller 220 may increase the output frame rate to match the display frame rate. Alternatively or additionally, in dynamically adjusting the frame rate of at least the two or more video frames, dynamic frame rate output controller 220 may be configured to decrease the frame rate of at least the two or more video frames to a display frame rate less than the source frame rate based on the result of the analyzing.

In some implementations, output frame generator 230 may be configured to output the stream of source video frames as the stream of output video frames.

Alternatively or additionally, output frame generator 230 may be configured to drop one or more frames of a still scene of the stream of source video frames in outputting the stream of output video frames. For instance, for a still scene, output frame generator 230 may drop one or more source video frames that are similar to one another.

Alternatively or additionally, output frame generator 230 may be configured to generate one or more interpolated frames for frame rate up-conversion in outputting the stream of output video frames.

FIG. 2B illustrates an example device 200B for FRC in accordance with another implementation of the present disclosure. Device 200B may perform various functions to implement techniques, processes and methods described herein, including at least a portion of architecture 100A, architecture 100B, architecture 100C described above as well as process 500 described below. Device 200B may be implemented in the form of a single IC chip or a chipset of multiple IC chips. For instance, device 200B may be a processor such as a CPU, a GPU or an ASIC. Device 200B may include a content adaptive FRC module 204.

Content adaptive FRC module 204 may be configured to receive a stream of video frames, analyze information associated with two or more video frames of the stream of video frames, and dynamically adjust a frame rate of at least the two or more video frames of the stream of video frames based on a result of the analyzing. In some implementations, as shown in FIG. 2B, content adaptive FRC module 204 may include at least those components shown in FIG. 2B, such as a video content analyzer 210, a dynamic frame rate output controller 220 and an output frame generator 230.

Content adaptive FRC module 204 may be in the form of hardware, software, middleware, firmware or any combination thereof. For example, content adaptive FRC module 204 may be implemented in a hardware form of a circuit or IC chip. As another example, content adaptive FRC module 204 may be implemented in a software form such as one or more sets of instructions executable by a CPU, a GPU or an ASIC.

As the structure and functionality of content adaptive FRC module 204 may be similar to those of content adaptive FRC module 202, the following description of content adaptive FRC module 204 is focused on differences between content adaptive FRC module 204 and content adaptive FRC module 202. That is, a detailed description of portions of content adaptive FRC module 204 that are similar to content adaptive FRC module 202 is not provided below in the interest of brevity.

In some implementations, video content analyzer 210 may be configured to receive information on the content of every two or more consecutive video frames from a video decoder (not shown). In some implementations, in analyzing the content of every two or more consecutive video frames of the stream of source video frames, video content analyzer 210 may be configured to analyze motion vectors, block residues, or a combination thereof regarding the stream of source video frames.

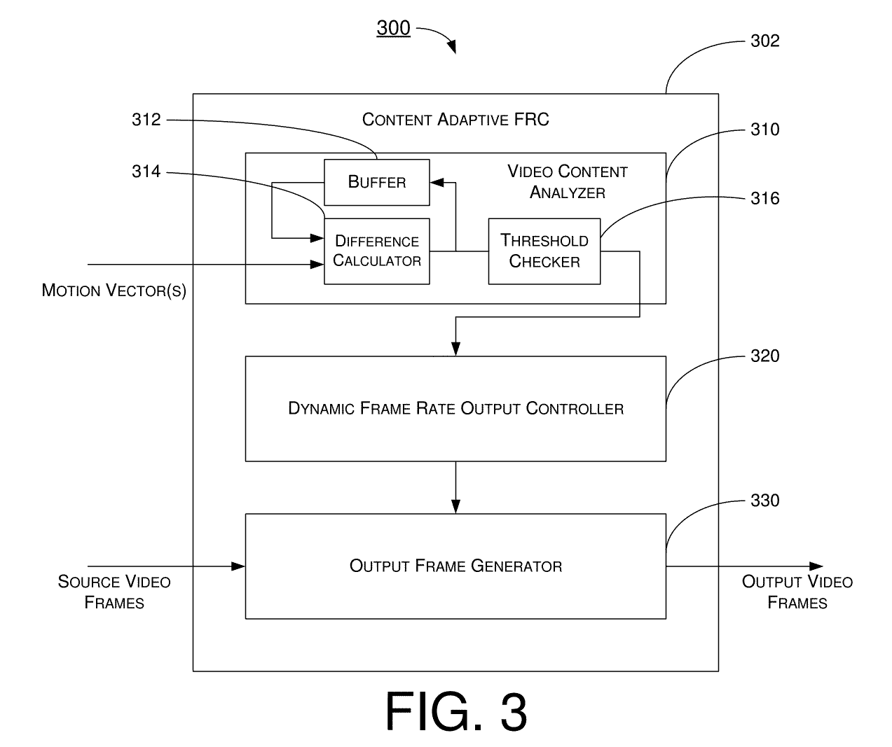

FIG. 3 illustrates an example device 300 for FRC in accordance with a further implementation of the present disclosure. Device 300 may perform various functions to implement techniques, processes and methods described herein, including at least a portion of architecture 100A, architecture 1008, architecture 100C described above as well as process 500 described below. Device 300 may be implemented in the form of a single IC chip or a chipset of multiple IC chips. For instance, device 200B may be a processor such as a CPU, a GPU or an ASIC. Device 300 may include a content adaptive FRC module 302.

Content adaptive FRC module 302 may be configured to receive a stream of video frames, analyze information associated with two or more video frames of the stream of video frames, and dynamically adjust a frame rate of at least the two or more video frames of the stream of video frames based on a result of the analyzing. In some implementations, content adaptive FRC module 302 may include at least those components shown in FIG. 3, such as a video content analyzer 310, a dynamic frame rate output controller 320 and an output frame generator 330.

Content adaptive FRC module 302 may be in the form of hardware, software, middleware, firmware or any combination thereof. For example, content adaptive FRC module 302 may be implemented in a hardware form of a circuit or IC chip. As another example, content adaptive FRC module 302 may be implemented in a software form such as one or more sets of instructions executable by a CPU, a GPU or an ASIC.

As the structure and functionality of content adaptive FRC module 302 may be similar to those of content adaptive FRC module 202 and/or content adaptive FRC module 204, the following description of content adaptive FRC module 302 is focused on differences between content adaptive FRC module 302 and content adaptive FRC modules 202 and 204. For instance, dynamic frame rate output controller 320 and output frame generator 330 may be similar or identical to dynamic frame rate output controller 220 and output frame generator 230. Thus, a detailed description of portions of content adaptive FRC module 302 that are similar to content adaptive FRC modules 202 and 204 is not provided below in the interest of brevity.

In some implementations, video content analyzer 310 may be configured to receive information (e.g., motion vectors) from a video decoder (e.g., an h.264 decoder which is not shown). In some implementations, in analyzing the content of every two or more consecutive video frames of the stream of source video frames, video content analyzer 310 may be configured to analyze the motion vectors and provide a result of the analysis to dynamic frame rate output controller 320.

Video content analyzer 310 may include a motion vector difference calculator 312, a buffer 314 and a threshold checker 316. For each motion vector received from the video decoder, motion vector difference calculator 312 may be configured to calculate or otherwise determine a difference between a current motion vector and a previous motion vector. Buffer 314 may be configured to store a value of the previous motion vector and replace it with a value of the current motion vector. Threshold checker 316 may be configured to receive, from motion vector difference calculator 312, a value representative of the difference to determine whether the difference between the current motion vector and the previous motion vector is greater than a predefined threshold. In an event that threshold checker 316 determines that the difference is greater than the predefined threshold, threshold checker 316 may trigger dynamic frame rate controller 320 to perform dynamically adjust the frame rate of at least the two or more video frames of the stream of source video frames. Otherwise, in an event that threshold checker 316 determines that the difference is not greater than the predefined threshold, threshold checker 316 may take no action to trigger dynamic frame rate controller 320.

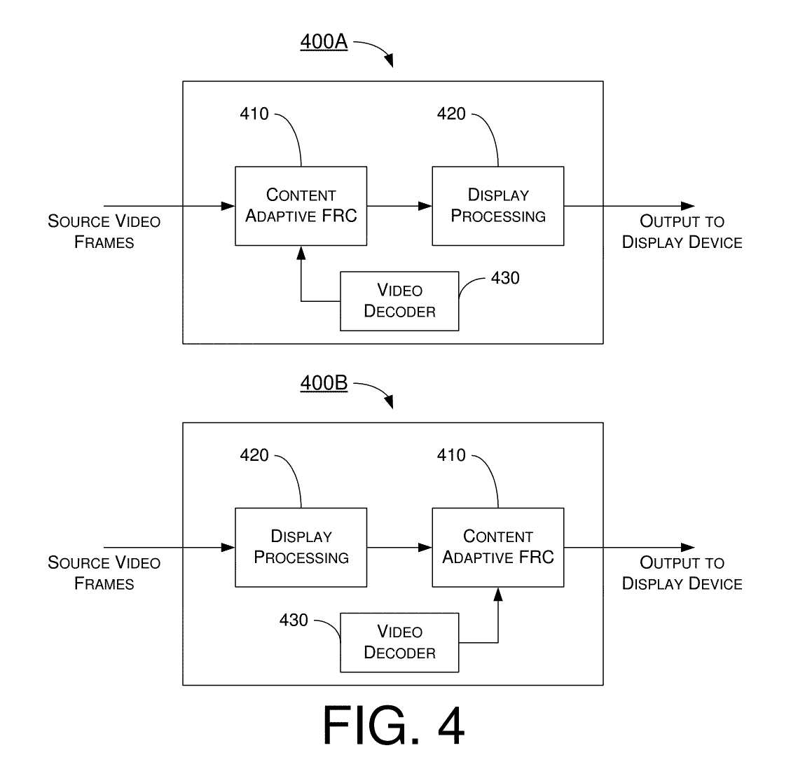

FIG. 4 illustrates an example apparatus 400A and another example apparatus 400B in accordance with an implementation of the present disclosure. Each of apparatus 400A and apparatus 400B may perform various functions to implement techniques, processes and methods described herein, including at least a portion of architecture 100A, architecture 1008, architecture 100C described above as well as process 500 described below. Each of apparatus 400A and apparatus 400B may be implemented in the form of a single IC chip or a chipset of multiple IC chips. In some implementations, each of apparatus 400A and apparatus 400B may be an electronic apparatus which may be a computing apparatus, a portable/mobile apparatus or a wearable apparatus. For instance, each of apparatus 400A and apparatus 400B may be a smartphone, smartwatch, a computing device such as a tablet computer, a laptop computer, a notebook computer, or a wearable apparatus. Each of apparatus 400A and apparatus 400B may include at least those components shown in FIG. 4, such as a content adaptive FRC module 410 and a display processing module 420. Although not shown in FIG. 4, each of apparatus 400A and apparatus 400B may optionally include additional components such as, for example, a source video module, a normal FRC module, a motion-compensated FRC module, a display module or device and/or a video decoder, and in some implementations one, some or all of these components may be external to either or both of apparatus 400A and apparatus 400B.

In each of apparatus 400A and apparatus 400B, display processing module 420 may be configured to process a stream of video frames. However, in apparatus 400A display processing module 420 may be coupled to receive the stream of video frames from content adaptive FRC module 410, and in apparatus 400B display processing module 420 may be coupled to provide the stream of video frames to content adaptive FRC module 410.

Content adaptive FRC module 410 may be implemented by either content adaptive FRC module 202 of device 200A, content adaptive FRC module 204 of device 200B or content adaptive FRC module 302 of device 300. That is, content adaptive FRC module 410 may adapt the structure/architecture of either content adaptive FRC module 202 of device 200A or content adaptive FRC module 204 of device 200B. In any case, content adaptive FRC module 410 may be configured to analyze information associated with two or more video frames of the stream of video frames. Content adaptive FRC module 410 may be also configured to dynamically adjust a frame rate of at least the two or more video frames of the stream of video frames based on a result of the analyzing.

In some implementations, in analyzing the information associated with the two or more video frames, content adaptive FRC module 410 may be configured to analyze a content of every two or more consecutive video frames of the stream of video frames. In some implementations, in analyzing the content of every two or more consecutive video frames of the stream of video frames, content adaptive FRC module 410 may be configured to analyze a texture, a motion speed, a motion complexity, or a combination thereof regarding the content of every two or more consecutive video frames of the stream of video frames. [0050]Optionally, each of apparatus 400A and apparatus 400B may also include a video decoder 430 configured to provide information regarding the stream of video frames, and content adaptive FRC module 410 may be configured to receive the information regarding the stream of video frames from video decoder 430. Specifically, in apparatus 400A, content adaptive FRC module 410 may be configured and coupled to receive a stream of source video frames from a source external of apparatus 400A in addition to receiving information regarding the source video frames from video decoder 430. In contrast, in apparatus 400B, content adaptive FRC module 410 may be configured and coupled to receive the stream of source video frames from display processing module 420 in addition to receiving information regarding the source video frames from video decoder 430. In such cases the information associated with the two or more video frames may include the information received from video decoder 430. In some implementations, the information received from video decoder 430 may include information on motion vectors, block residues, or a combination thereof regarding the stream of video frames.

In some implementations, in dynamically adjusting the frame rate of at least the two or more video frames, content adaptive FRC module 410 may be configured to maintain the frame rate of at least the two or more video frames at a source frame rate of the stream of video frames based on the result of the analyzing. Alternatively or additionally, in dynamically adjusting the frame rate of at least the two or more video frames, content adaptive FRC module 410 may be configured to adjust the frame rate of at least the two or more video frames to be between a source frame rate of the stream of video frames and a display frame rate based on the result of the analyzing, with the display frame rate being different from (e.g., greater than or less than) the source frame rate. Alternatively or additionally, in dynamically adjusting the frame rate of at least the two or more video frames, content adaptive FRC module 410 may be configured to increase the frame rate of at least the two or more video frames to a display frame rate, which is greater than a source frame rate of the stream of video frames, based on the result of the analyzing. Alternatively or additionally, in dynamically adjusting the frame rate of at least the two or more video frames, content adaptive FRC module 410 may be configured to decrease the frame rate of at least the two or more video frames to a display frame rate, which is less than a source frame rate of the stream of video frames, based on the result of the analyzing.

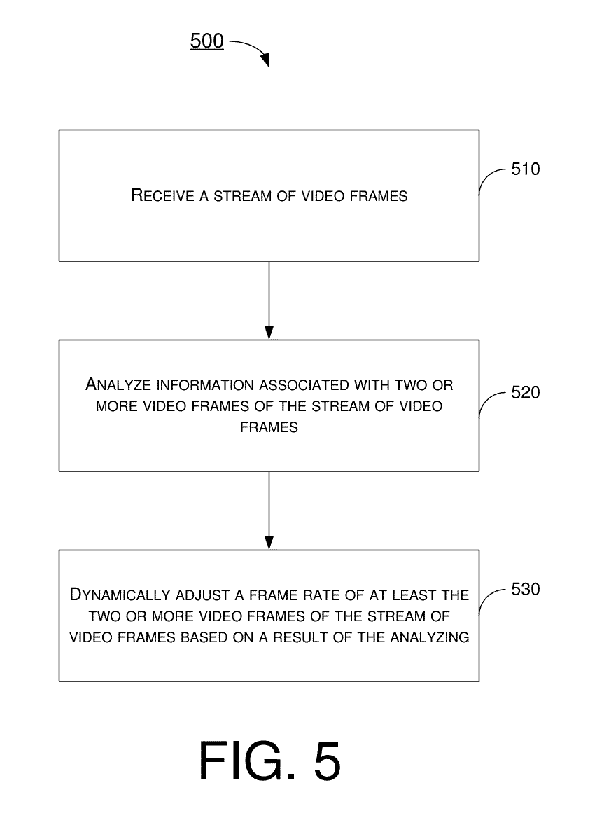

FIG. 5 illustrates an example process 500 in accordance with an implementation of the present disclosure. Process 500 may include one or more operations, actions, or functions as represented by one or more blocks such as blocks 510, 520 and 530. Although illustrated as discrete blocks, various blocks of process 500 may be divided into additional blocks, combined into fewer blocks, or eliminated, depending on the desired implementation. The blocks may be performed in the order shown in FIG. 5 or in any other order, depending on the desired implementation. Process 500 may be implemented by content adaptive FRC module 120, device 200A, device 200B, device 300, apparatus 400A and apparatus 400B. Solely for illustrative purpose and without limiting the scope of the present disclosure, process 500 is described below in the context of process 500 being performed by content adaptive FRC module 120. Process 500 may begin at 510.

At 510, process 500 may involve content adaptive FRC module 120 receiving a stream of video frames from source video module 110 (e.g., in architecture 100A and architecture 100B) or from display processing module 130 (e.g., in architecture 100C). Process 500 may proceed from 510 to 520.

At 520, process 500 may involve content adaptive FRC module 120 analyzing information associated with two or more video frames of the stream of video frames. Process 500 may proceed from 520 to 530.

At 530, process 500 may involve content adaptive FRC module 120 dynamically adjusting a frame rate of at least the two or more video frames of the stream of video frames based on a result of the analyzing.

In some implementations, in analyzing the information associated with the two or more video frames, process 500 may involve content adaptive FRC module 120 analyzing a content of every two or more consecutive video frames of the stream of video frames. In some implementations, in analyzing the content of every two or more consecutive video frames of the stream of video frames, process 500 may involve content adaptive FRC module 120 analyzing a texture, a motion speed, a motion complexity, or a combination thereof regarding the content of every two or more consecutive video frames of the stream of video frames.

In some implementations, the information associated with the two or more video frames may include information received from a video decoder regarding the stream of video frames. In some implementations, the information received from the video decoder may include information on motion vectors, block residues, or a combination thereof regarding the stream of video frames.

In some implementations, in dynamically adjusting the frame rate of at least the two or more video frames, process 500 may involve content adaptive FRC module 120 maintaining the frame rate of at least the two or more video frames at a source frame rate of the stream of video frames based on the result of the analyzing.

Alternatively or additionally, in dynamically adjusting the frame rate of at least the two or more video frames, process 500 may involve content adaptive FRC module 120 adjusting the frame rate of at least the two or more video frames to be between a source frame rate of the stream of video frames and a display frame rate based on the result of the analyzing, with the display frame rate being different from (e.g., greater than or less than) the source frame rate.

Alternatively or additionally, in dynamically adjusting the frame rate of at least the two or more video frames, process 500 may involve content adaptive FRC module 120 increasing the frame rate of at least the two or more video frames to a display frame rate, which is greater than a source frame rate of the stream of video frames, based on the result of the analyzing.

Alternatively or additionally, in dynamically adjusting the frame rate of at least the two or more video frames, process 500 may involve content adaptive FRC module 120 decreasing the frame rate of at least the two or more video frames to a display frame rate, which is less than a source frame rate of the stream of video frames, based on the result of the analyzing.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
analyzing information associated with two or more video frames of a stream of video frames; and
dynamically adjusting a frame rate of at least the two or more video frames of the stream of video frames based on a result of the analyzing.

2. The method of claim 1, wherein the analyzing of the information associated with the two or more video frames comprises analyzing a content of every two or more consecutive video frames of the stream of video frames.

3. The method of claim 2, wherein the analyzing of the content of every two or more consecutive video frames of the stream of video frames comprises analyzing a texture, a motion speed, a motion complexity, or a combination thereof regarding the content of every two or more consecutive video frames of the stream of video frames.

4. The method of claim 1, wherein the information associated with the two or more video frames comprises information received from a video decoder regarding the stream of video frames.

5. The method of claim 4, wherein the information received from the video decoder comprises information on motion vectors, block residues, or a combination thereof regarding the stream of video frames.

6. The method of claim 1, wherein the dynamically adjusting of the frame rate of at least the two or more video frames comprises maintaining the frame rate of at least the two or more video frames at a source frame rate of the stream of video frames based on the result of the analyzing.

7. The method of claim 1, wherein the dynamically adjusting of the frame rate of at least the two or more video frames comprises adjusting the frame rate of at least the two or more video frames to be between a source frame rate of the stream of video frames and a display frame rate based on the result of the analyzing, and wherein the display frame rate and the source frame rate are different.

8. The method of claim 1, wherein the dynamically adjusting of the frame rate of at least the two or more video frames comprises increasing the frame rate of at least the two or more video frames to a display frame rate, which is greater than a source frame rate of the stream of video frames, based on the result of the analyzing.

9. The method of claim 1, wherein the dynamically adjusting of the frame rate of at least the two or more video frames comprises decreasing the frame rate of at least the two or more video frames to a display frame rate, which is less than a source frame rate of the stream of video frames, based on the result of the analyzing.

10. A device, comprising:
a frame rate conversion (FRC) module configured to perform operations comprising:
analyzing information associated with two or more video frames of a stream of video frames; and
dynamically adjusting a frame rate of at least the two or more video frames of the stream of video frames based on a result of the analyzing.

11. The device of claim 10, wherein the FRC module comprises:
a video content analyzer configured to analyze a content of every two or more consecutive video frames of the stream of video frames;
a dynamic frame rate output controller configured to dynamically adjust the frame rate of at least the two or more video frames of the stream of video frames based on a result of analyzing by the video content analyzer; and
an output frame generator configured to receive the stream of video frames at a source frame rate and output a stream of output video frames at an output frame rate.

12. The device of claim 11, wherein the video content analyzer is configured to obtain information on the content of every two or more consecutive video frames from the stream of video frames, and wherein, in analyzing the content of every two or more consecutive video frames of the stream of video frames, the video content analyzer is configured to analyze a texture, a motion speed, a motion complexity, or a combination thereof regarding the content of every two or more consecutive video frames of the stream of video frames.

13. The device of claim 11, wherein the video content analyzer is configured to receive information on the content of every two or more consecutive video frames from a video decoder, and wherein, in analyzing the content of every two or more consecutive video frames of the stream of video frames, the video content analyzer is configured to analyze motion vectors, block residues, or a combination thereof regarding the stream of video frames.

14. The device of claim 11, wherein, in dynamically adjusting the frame rate of at least the two or more video frames, the dynamic frame rate output controller is configured to maintain the frame rate of at least the two or more video frames at the source frame rate based on the result of the analyzing.

15. The device of claim 11, wherein, in dynamically adjusting the frame rate of at least the two or more video frames, the dynamic frame rate output controller is configured to adjust the frame rate of at least the two or more video frames to be between the source frame rate and a display frame rate based on the result of the analyzing, and wherein the display frame rate and the source frame rate are different.

16. The device of claim 11, wherein, in dynamically adjusting the frame rate of at least the two or more video frames, the dynamic frame rate output controller is configured to increase the frame rate of at least the two or more video frames to a display frame rate greater than the source frame rate based on the result of the analyzing.

17. The device of claim 11, wherein, in dynamically adjusting the frame rate of at least the two or more video frames, the dynamic frame rate output controller is configured to decrease the frame rate of at least the two or more video frames to a display frame rate less than the source frame rate based on the result of the analyzing.

18. The device of claim 11, wherein the output frame generator is configured to output the stream of video frames as the stream of output video frames.

19. The device of claim 11, wherein the output frame generator is configured to drop one or more frames of a still scene of the stream of video frames in outputting the stream of output video frames.

20. The device of claim 11, wherein the output frame generator is configured to generate one or more interpolated frames for frame rate up-conversion in outputting the stream of output video frames.

21. An apparatus, comprising:
a frame rate conversion (FRC) module configured to perform operations comprising:
analyzing information associated with two or more video frames of a stream of video frames; and
dynamically adjusting a frame rate of at least the two or more video frames of the stream of video frames based on a result of the analyzing; and
a display processing module configured to process the stream of video frames.

22. The apparatus of claim 21, wherein, in analyzing the information associated with the two or more video frames, the FRC module is configured to analyze a content of every two or more consecutive video frames of the stream of video frames.

23. The apparatus of claim 22, wherein, in analyzing the content of every two or more consecutive video frames of the stream of video frames, the FRC module is configured to analyze a texture, a motion speed, a motion complexity, or a combination thereof regarding the content of every two or more consecutive video frames of the stream of video frames.

24. The apparatus of claim 21, further comprising:
a video decoder configured to provide information regarding the stream of video frames,
wherein the FRC module is further configured to receive the information regarding the stream of video frames from the video decoder,
wherein the information associated with the two or more video frames comprises the information received from the video decoder, and
wherein the information received from the video decoder comprises information on motion vectors, block residues, or a combination thereof regarding the stream of video frames.

25. The apparatus of claim 21, wherein, in dynamically adjusting the frame rate of at least the two or more video frames, the FRC module is configured to maintain the frame rate of at least the two or more video frames at a source frame rate of the stream of video frames based on the result of the analyzing.

26. The apparatus of claim 21, wherein, in dynamically adjusting the frame rate of at least the two or more video frames, the FRC module is configured to adjust the frame rate of at least the two or more video frames to be between a source frame rate of the stream of video frames and a display frame rate based on the result of the analyzing, and wherein the display frame rate and the source frame rate are different.

27. The apparatus of claim 21, wherein, in dynamically adjusting the frame rate of at least the two or more video frames, the FRC module is configured to increase the frame rate of at least the two or more video frames to a display frame rate, which is greater than a source frame rate of the stream of video frames, based on the result of the analyzing.

28. The apparatus of claim 21, wherein, in dynamically adjusting the frame rate of at least the two or more video frames, the FRC module is configured to decrease the frame rate of at least the two or more video frames to a display frame rate, which is less than a source frame rate of the stream of video frames, based on the result of the analyzing.

29. The apparatus of claim 21, wherein the display processing module is coupled to receive the stream of video frames from the FRC module.

30. The apparatus of claim 21, wherein the display processing module is coupled to provide the stream of video frames to the FRC module.
